(19) United States
(12) Patent Application Publication
(10) Pub. No.: US 2023/0112399 A1
(43) Pub. Date: Apr. 13, 2023

(54) ATOMIZING DEVICE

(71) Applicant: Lantian GUO, Shenzhen (CN)

(72) Inventor: Guiming LIU, Shenzhen (CN)

(21) Appl. No.: 17/643,369

(22) Filed: Dec. 8, 2021

(30) Foreign Application Priority Data
Oct. 12, 2021 (CN) 202122457661.5

(51) Int. Cl. A24F 40/46; A24F 40/485; A24F 40/10; H05B 3/48

(52) U.S. Cl. CPC A24F 40/46; A24F 40/485; A24F 40/10; H05B 3/48; H05B 2203/016; H05B 2203/002

(57) ABSTRACT

The present invention relates to the technical field of atomization and discloses an atomizing device which comprises a heating part, a glass heating element and a quartz holder, wherein the heating part is embedded in the glass heating element, the quartz holder is made with a through-holding cavity, the glass heating element is arranged in the holding cavity, the quartz holder is made with auxiliary air inlet holes on the side wall, and the glass heating element is made with a heating element air passage communicating with the auxiliary air inlet holes so as to meet the user's needs for atomized tobacco tar, thus facilitating atomization of tobacco tar.

### BACKGROUND OF THE PRESENT INVENTION

### Field of Invention

The present invention relates to the technical field of atomization, and more specifically, to an atomizing device.

### Description of Related Arts

E-cigarette devices typically comprise tobacco tar which is subject to atomization upon heating, thus producing inhalable vapor or aerosol. Usually, e-cigarette devices in the market include a porous ceramic body with a large number of micropores inside for absorbing and conducting the tobacco tar, and a heating element on one surface of the porous ceramic body to heat the absorbed tobacco tar for atomization. On the one hand, the micropores inside the porous body are used as a channel for the infiltrating flow of tobacco tar onto the atomized surface. On the other hand, they are used as an air exchange channel for air to enter the oil storage cavity from the outside after the tobacco tar in the cavity is consumed to maintain the air pressure balance in the cavity, so that when the tobacco tar is consumed by heating and atomization, bubbles will be generated in the porous ceramic body, and then bubbles will emerge from the suction surface and enter the oil storage cavity.

The use of microporous ceramic body as part of the electronic atomizing device is a common practice in the e-cigarette industry. In recent years, to further precisely control the burning speed of tobacco tar and optimize the taste of smoking, porous glass has been tried to function as part of the electronic atomizing device in the e-cigarette industry. For the atomizing device using porous glass, the structure of the atomizer needs to be improved to adapt to the porous glass as its heating unit, boasting the advantages of simple manufacture and ease of use.

Therefore, how to provide an atomizing device to facilitate the atomization of tobacco tar has become a pressing technical problem to be solved.

### SUMMARY OF THE PRESENT INVENTION

The technical problem to be solved by the present invention lies in how to provide an atomizing device to facilitate the atomization of tobacco tar.

To this end, according to the first aspect, the embodiment of the present invention discloses an atomizing device, comprising: a heating part, a glass heating element and a quartz holder, wherein the heating part is embedded in the glass heating element, the quartz holder is made with a through-holding cavity, the glass heating element is arranged in the holding cavity, the quartz holder is made with auxiliary air inlet holes on the side wall, and the glass heating element is made with a heating element air passage communicating with the auxiliary air inlet holes.

The present invention is further such that that the side wall of the quartz holder is made with auxiliary tar inlet holes, and the side wall of the glass heating element is made with heating element projections corresponding to the auxiliary tar inlet holes.

The present invention is further such that the heating element projections and the glass heating elements are integrally formed.

The present invention is further such that the heating part is a heating wire which consists of a heating helix and first leads, wherein the heating helix is embedded in the glass heating element and the first leads are connected with the end of the heating helix.

The present invention is further such that the heating part is a heating tube which consists of a heating cylinder and second leads, wherein the heating cylinder is hollow inside, the second leads are connected to the heating cylinder, and the heating cylinder is embedded in the glass heating element.

The present invention is further such that the number of the auxiliary air inlet holes is two and the two auxiliary air inlet holes are symmetrically distributed in the side wall of the quartz holder.

The present invention is further such that the glass heating element, made of porous glass, includes a number of glass particles whose diameter is less than 0.5 mm.

The present invention has the following beneficial effects: an atomizing device is provided by embedding the heating part in the glass heating element, making a through-holding cavity in the quartz holder, arranging the glass heating element in the holding cavity, making auxiliary air inlet holes in the side wall of the quartz holder, and making a heating element air passage in the glass heating element to communicate with the auxiliary air inlet holes. The dipping end of the glass heating element of the atomizing device is dipped into the tobacco tar liquid to be atomized, the glass heating element is heated for atomization by the heating wire and heating tube, and an atomized airflow is formed in the auxiliary air inlet holes and the heating element air passage to meet the user's needs for atomized tobacco tar, thus facilitating atomization of tobacco tar.

### BRIEF DESCRIPTION OF THE DRAWINGS

The drawings used in describing the embodiment or the prior art are briefed hereinafter to better understand the technical solution of the embodiment of the present invention or the prior art. It is apparent that the drawings in the following description only serve as some embodiments of the present invention. Those skilled in the field may make other drawings based on these drawings without contributing creative labor.

FIG. 1 is a perspective view of the structure of an atomizing device disclosed in the embodiment;

FIG. 2 is an explosive view of the structure of an atomizing device disclosed in the embodiment;

FIG. 3 is an explosive view of the structure of another atomizing device disclosed in the embodiment;

FIG. 4 is a sectional view of the structure of an atomizing device disclosed in the embodiment;

FIG. 5 is a sectional view of the structure of another atomizing device disclosed in the embodiment.

Reference numbers in the drawings: 1. heating wire, 2. heating helix, 12. first lead, 2. heating tube, 21. heating cylinder, 22. second lead, 3. glass heating element, 31. heating element air passage, 32. heating element projection, 4. quartz holder, 41. holding cavity, 42. auxiliary air inlet hole, 43. auxiliary tar inlet hole.

### DETAILED DESCRIPTION OF THE PREFERRED EMBODIMENT

In order to give a clearer description of the object, technical solution and advantages of the present invention, the present invention is further detailed hereafter in combination with the drawings and embodiments. It shall be understood that the specific embodiments described herein are only to illustrate rather than to limit the present invention.

In the description of the present invention, it should be noted that unless otherwise specified and defined expressly, the terms “install”, “connected” and “connect” should be understood in a broad sense. For example, it can be a fixed connection, a detachable connection, or an integral connection; it can be a mechanical connection, or an electrical connection; it can be a direct connection, an indirect connection through an intermedium, or an internal connectivity between two elements; or it can be a wireless connection or a wired connection. For those skilled in this art, the specific meaning of the terms in the present invention can be understood in combination with specific circumstances.

In the description of the present invention, it should be noted that terms such as “center”, “above”, “below”, “left”, “right”, “vertical”, “horizontal”, “inside” and “outside” indicates the orientation or positional relationship based on the drawings, and are only for the convenience of description of the present invention and for simplifying the description, not for indicating or implying that the device or element must have a specific orientation, be constructed or operated in a specific orientation. Therefore, they should not be construed as limiting the present invention. In addition, the terms “first”, “second”, and “third” are only used for descriptive purposes, and should not be understood as indicating or implying relative importance.

In addition, the technical features involved in the different embodiments of the present invention described below may be combined with each other as long as they do not conflict with each other.

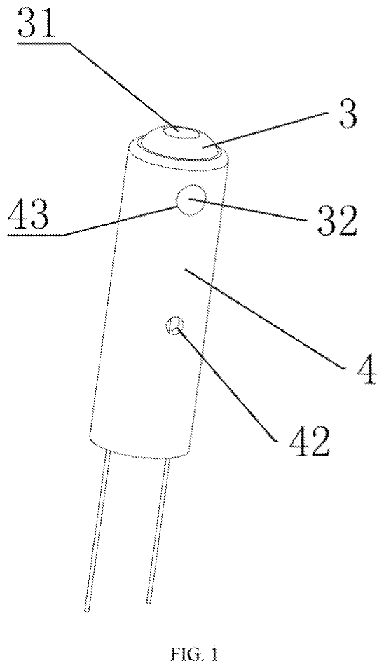

The embodiment of the present invention discloses an atomizing device, as shown in FIGS. 1-5, comprising: a heating part, a glass heating element 3 and a quartz holder 4, wherein the heating part is embedded in the glass heating element 3, the quartz holder 4 is made with a through-holding cavity 41, the glass heating element 3 is arranged in the holding cavity 41, the quartz holder 4 is made with auxiliary air inlet holes 42 on the side wall, and the glass heating element 3 is made with a heating element air passage 31 communicating with the auxiliary air inlet holes 42.

It should be noted that an atomizing device is provided by embedding the heating part in the glass heating element 3, making a through-holding cavity 41 in the quartz holder 4, arranging the glass heating element 3 in the holding cavity 41, making auxiliary air inlet holes 42 in the side wall of the quartz holder 4, and making a heating element air passage 31 in the glass heating element 3 to communicate with the auxiliary air inlet holes 42. The dipping end of the glass heating element 3 of the atomizing device is dipped into the tobacco tar liquid to be atomized, the glass heating element 3 is heated for atomization by the heating part, and an atomized airflow is formed in the auxiliary air inlet holes 42 and the heating element air passage 31 to meet the user's needs for atomized tobacco tar, thus facilitating atomization of tobacco tar.

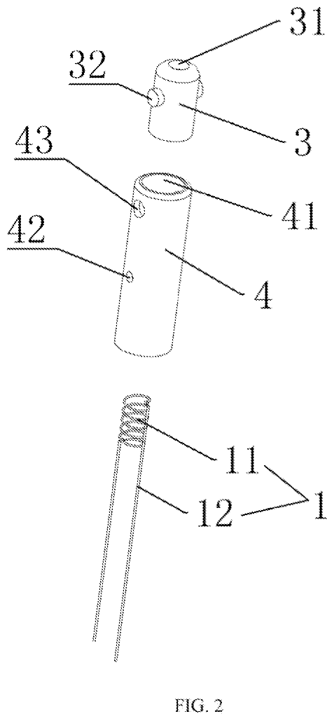

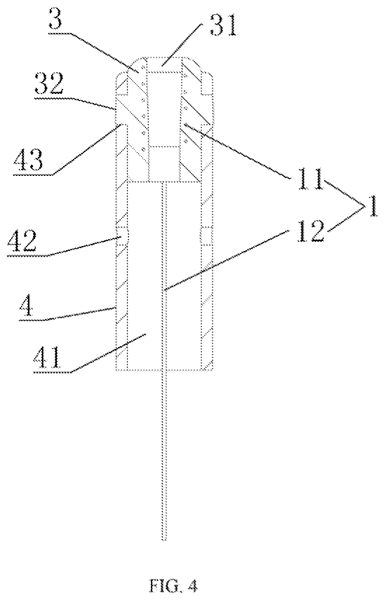

As shown in FIG. 2 and FIG. 4, the side wall of the quartz holder 4 is made with auxiliary tar inlet holes 43, and the side wall of the glass heating element 3 is made with heating element projections 32 corresponding to the auxiliary tar inlet holes 43.

As shown in FIG. 2 and FIG. 4, the heating element projections 32 and the glass heating elements 3 are integrally formed.

As shown in FIG. 2 and FIG. 4, the heating part is a heating wire 1 which consists of a heating helix 11 and first leads 12, wherein the heating helix 11 is embedded in the glass heating element 3 and the first leads 12 are connected with the end of the heating helix 11.

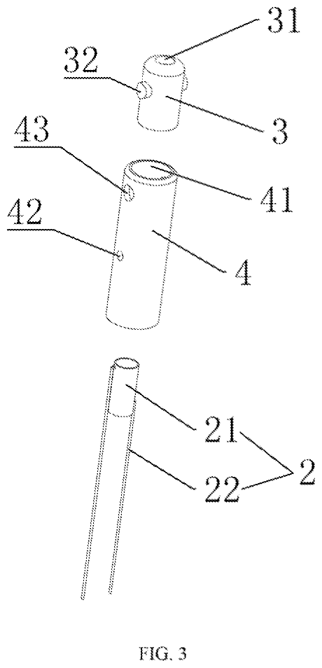

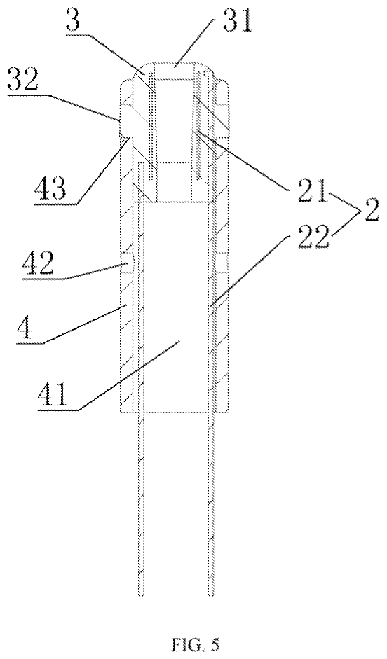

As shown in FIG. 3 and FIG. 5, the heating part is a heating tube 2 which consists of a heating cylinder 21 and second leads 22, wherein the heating cylinder 21 is hollow inside, the second leads 22 are connected to the heating cylinder 21, and the heating cylinder 21 is embedded in the glass heating element 3.

As shown in FIGS. 1-5, the number of the auxiliary air inlet holes 42 is two and the two auxiliary air inlet holes 42 are symmetrically distributed in the side wall of the quartz holder 4.

As shown in FIG. 2, the glass heating element 3, made of porous glass, includes a number of glass particles whose diameter is less than 0.5 mm.

Operating principle: an atomizing device is provided by embedding the heating wire 1 or heating tube 2 in the glass heating element 3, making a through-holding cavity 41 in the quartz holder 4, arranging the glass heating element 3 in the holding cavity 41, making auxiliary air inlet holes 42 in the side wall of the quartz holder 4, and making a heating element air passage 31 in the glass heating element 3 to communicate with the auxiliary air inlet holes 42. The dipping end of the glass heating element 3 of the atomizing device is dipped into the tobacco tar liquid to be atomized, the glass heating element 3 is heated for atomization by the heating wire 1 or heating tube 2, and an atomized airflow is formed in the auxiliary air inlet holes 42 and the heating element air passage 31 to meet the user's needs for atomized tobacco tar, thus facilitating atomization of tobacco tar.

Obviously, the above embodiments are only examples given for a clear description, and not intended to limit the embodiments. Those skilled in this art can make other forms of modifications and variations based on the description given above. There is no need and no way to give any other examples for all embodiments. All the obvious modifications and variations based on the solutions herein should be covered in the protection scope of the Claims of the present invention.

What is claimed is:

1. An atomizing device, characterized in that, comprising: a heating part, a glass heating element (3) and a quartz holder (4), wherein the heating part is embedded in the glass heating element (3), the quartz holder (4) is made with a through-holding cavity (41), the glass heating element (3) is arranged in the holding cavity (41), the quartz holder (4) is made with auxiliary air inlet holes (42) on the side wall, and the glass heating element (3) is made with a heating element air passage (31) communicating with the auxiliary air inlet holes (42).

2. The atomizing device accordingly to claim 1, characterized in that the side wall of the quartz holder (4) is made with auxiliary tar inlet holes (43), and the side wall of the glass heating element (3) is made with heating element projections (32) corresponding to the auxiliary tar inlet holes (43).

3. The atomizing device accordingly to claim 2, characterized in that the heating element projections (32) and the claim glass heating elements (3) are integrally formed.

4. The atomizing device accordingly to any one of claim 1, characterized in that the heating part is a heating wire (1) which consists of a heating helix (11) and first leads (12), wherein the heating helix (11) is embedded in the glass heating element (3) and the first leads (12) are connected with the end of the heating helix (11).

5. The atomizing device accordingly to any one of claim 1, characterized in that the heating part is a heating tube (2) which consists of a heating cylinder (21) and second leads (22), wherein the heating cylinder (21) is hollow inside, the second leads (22) are connected to the heating cylinder (21), and the heating cylinder (21) is embedded in the glass heating element (3).

6. The atomizing device accordingly to any one of claim 1, characterized in that the number of the auxiliary air inlet holes (42) is two and the two auxiliary air inlet holes (42) are symmetrically distributed in the side wall of the quartz holder (4).

7. The atomizing device accordingly to any one of claim 1, characterized in that the glass heating element (3), made of porous glass, includes a number of glass particles whose diameter is less than 0.5 mm.

8. The atomizing device accordingly to any one of claim 2, characterized in that the heating part is a heating wire (1) which consists of a heating helix (11) and first leads (12), wherein the heating helix (11) is embedded in the glass heating element (3) and the first leads (12) are connected with the end of the heating helix (11).

9. The atomizing device accordingly to any one of claim 3, characterized in that the heating part is a heating wire (1) which consists of a heating helix (11) and first leads (12), wherein the heating helix (11) is embedded in the glass heating element (3) and the first leads (12) are connected with the end of the heating helix (11).

10. The atomizing device accordingly to any one of claim 2, characterized in that the heating part is a heating tube (2) which consists of a heating cylinder (21) and second leads (22), wherein the heating cylinder (21) is hollow inside, the second leads (22) are connected to the heating cylinder (21), and the heating cylinder (21) is embedded in the glass heating element (3).

11. The atomizing device accordingly to any one of claim 3, characterized in that the heating part is a heating tube (2) which consists of a heating cylinder (21) and second leads (22), wherein the heating cylinder (21) is hollow inside, the second leads (22) are connected to the heating cylinder (21), and the heating cylinder (21) is embedded in the glass heating element (3).

12. The atomizing device accordingly to any one of claim 2, characterized in that the number of the auxiliary air inlet holes (42) is two and the two auxiliary air inlet holes (42) are symmetrically distributed in the side wall of the quartz holder (4).

13. The atomizing device accordingly to any one of claim 3, characterized in that the number of the auxiliary air inlet holes (42) is two and the two auxiliary air inlet holes (42) are symmetrically distributed in the side wall of the quartz holder (4).

14. The atomizing device accordingly to any one of claim 2, characterized in that the glass heating element (3), made of porous glass, includes a number of glass particles whose diameter is less than 0.5 mm.

15. The atomizing device accordingly to any one of claim 3, characterized in that the glass heating element (3), made of porous glass, includes a number of glass particles whose diameter is less than 0.5 mm.
